(19) United States
(12) Patent Application Publication
(10) Pub. No.: US 2023/0202063 A1
(43) Pub. Date: Jun. 29, 2023

(54) A CUTTING UNIT

(71) Applicant: KONINKLIJKE PHILIPS N.V., EINDHOVEN (NL)

(72) Inventors: Gilbert Hendrik VAN VELDHUIZEN, GRONINGEN (NL); Marcus Franciscus EIJKELKAMP, GRONINGEN (NL); Joop HENDRIKS, GRONINGEN (NL)

(21) Appl. No.: 17/914,899

(22) PCT Filed: Mar. 29, 2021
(86) PCT No.: PCT/EP2021/058060

§ 371 Date: Sep. 27, 2022

(30) Foreign Application Priority Data
Apr. 1, 2020 (EP) 20167617.8

(51) Int. Cl. B26B 19/20; B26B 19/04; B26B 19/38

(52) U.S. Cl. CPC B26B 19/205; B26B 19/04; B26B 19/3853

(57) ABSTRACT

The present invention relates to a cutting unit for a hair-cutting device. A cutting unit 14 is provided that comprises a tapered stationary guard blade 18 and a reciprocating cutter blade 16 in which the stationary guard blade is arranged to be moved perpendicular to the reciprocal motion of the cuter blade to allow the selection of different length settings. The guard blade may be biased to a minimal length setting. The stationary guard blade may be configured to be actuated by a user to allow a stepless change of the cutting length, when the stationary guard blade is pushed from its biased start position to the other end position.

### FIELD OF THE INVENTION

The present invention relates to a cutting unit for a hair-cutting device and to a hair-cutting device.

### BACKGROUND OF THE INVENTION

Hair clippers being able to cut hairs at a set of predefined hair lengths are well known e.g. from U.S. Pat. No. 1,861,616. Users may select one of these predefined lengths to use the device. As a set of discrete settings is available, it is not possible for the user to create a continuous fade other than by using advanced hair cutting skills. U.S. Pat. No. 1,774,046 discloses a clipper blade construction wherein the stationary blade is adjustable to provide varying length settings. U.S. Pat. No. 1,774,046 proposes to have a screw adjustment mechanism, the screw being positioned at the backside (i.e. the side opposing the side with the stationary blade teeth). U.S. Pat. No. 1,745,997 discloses a hair clipper in which the stationary blade is adjustable to adjust the cutting length by the user pushing a flexible connector which at one side is connected to the rear end of a combined cutter and comb member and at the other side to the part of the handle opposite to the part to which the cutter and comb member are connected.

Typically, hair clippers comprise a stationary guard blade and a reciprocating cutter blade delivering a factory set remaining hair length when used without comb. More advanced clippers allow the stationary guard blade of tapered shape to be moved perpendicular to the reciprocal motion of the cutter blade to allow the selection of different length settings, which is also known as so-called tip to tip adjustment system. In these advanced clippers the tip to tip length settings are predefined and discrete, still not allowing the user to create a continuous fade without advanced skills.

### SUMMARY OF THE INVENTION

There may be a need to facilitate a user to create a continuous fade during cutting.

The object of the present invention is solved by the subject-matter of the independent claims, wherein further embodiments are incorporated in the dependent claims. It should be noted that the following described aspects of the invention apply also for the cutting unit and the hair-cutting device.

According to a first aspect of the present invention, there is provided a cutting unit for a hair-cutting device. The cutting unit comprises a cutter blade with a first toothed leading edge and a guard blade. The guard blade comprises a blade-facing surface at least engaging the cutter blade at a cut location and a guard contact surface for contacting skin of a user. The guard blade further comprises a substantially planar lower surface terminating at the guard contact surface and being parallel to the blade facing surface of the guard blade. The guard contact surface and the blade-facing surface are angled with respect to each other and converge towards a second toothed leading edge with a plurality of hair-receiving slots. The at least one of the cutter blade and the guard blade is configured to reciprocate in a reciprocation direction such that the first toothed leading edge of the cutter blade is in a hair shearing relationship with the second toothed leading edge of the guard blade. The guard blade is a longitudinally moveable blade mounted for moving in a direction perpendicular to the reciprocation direction so as to adjust a length of hairs sheared between the guard blade and the cutter blade. The guard blade comprises a structure being accessible by a finger of the user to move the guard blade in the direction perpendicular to the reciprocation direction to allow a continuous adjustment of the length of hairs sheared between the guard blade and the cutter blade. The structure is located on the planar lower surface of the guard blade.

In other words, a cutting unit is provided that comprises a tapered guard blade and a reciprocating cutter blade in which the guard blade is arranged to be moved perpendicular to the reciprocal motion of the cuter blade to allow the selection of different length settings. The guard blade may be biased to a minimal length setting. The guard blade may be configured to be actuated by a user to allow a stepless change of the cutting length, when the guard blade is pushed from its biased start position to the other end position. In an example, a structure (e.g. knob, button, etc.) is added to the guard blade to allow user operation. This will be explained hereafter and in particular with respect to the embodiment illustrated in FIG. 1. In another example, an attachment with e.g. a knob, button, etc., is provided, which is attachable to the guard blade to allow user operation. This will be explained hereafter and in particular with respect to the embodiments illustrated in FIGS. 2A and 2B. In a further example, the attachment may be a click-on comb, which is attachable to the guard blade to allow user operation. This will be explained hereafter and in particular with respect to the embodiments illustrated in FIGS. 3A and 3B.

With the proposed cutting unit, the user can manually push the guard forward, overruling the set length to a larger length. The further the user pushes forward, the longer the cut hair length. Accordingly, the cutting length changes dynamically, which allows a continuous fade to be created. Further, as the push point is directly on the guard blade, no additional lever system is required. As less parts are needed, cost and complexity may be reduced.

According to an embodiment of the present invention, the structure is an integral part of the guard blade.

For example, the structure is a button or a knob that projects on the guard blade. For example, the structure is a recess on the guard blade. The structure may be knurled on its surface to facilitate manual operation by the finger of the user.

According to an embodiment of the present invention, the structure is an attachment attachable to the guard blade, wherein the attachment is accessible by a finger of the user to move the guard blade in the direction perpendicular to the reciprocation direction, when being attached to the guard blade.

The attachment may be configured to be attached to the guard blade in a releasable fashion. The guard blade may be constructed to receive the attachment. For example, an adapter may be mounted to the guard blade for receiving the attachment. An example of the adapter is illustrated in FIGS. 2 and 3. Once attached, the user can push the attachment forward to move the guard blade.

According to an embodiment of the present invention, the attachment is a comb arrangement with a frontal portion arranged to be disposed at the guard contact surface of the guard blade to create a tilt angle between the cutting unit and the skin of the user.

The comb arrangement may also be referred to as click-on fade comb. In other words, it is also possible to make fades with a larger range if the user adjusts the angle of the comb teeth. A larger angle will result in more change in cut hair length when the user pushes on e.g. a knob, and thus a bigger fade range. This will be explained hereafter and in particular with respect to the embodiment illustrated in FIGS. 3A and 3B.

According to an embodiment of the present invention, the guard blade is presetable in a position selected from a set of predefined positions to allow a selection of different hair cutting length settings.

According to an embodiment of the present invention, the guard blade is configured to be disengaged from a selected position during use when the structure is pressed inwardly, thus permitting slidable movement thereof.

In other words, in order to adjust the cutting length, the user may be required to press the structure by the finger to disengage the guard blade from a selected position followed by stepless sliding the guard blade by the same finger to create a continuous fade.

This may prevent unintentional change to the fade cutting mode during the hair shearing operation.

According to an embodiment of the present invention, the guard blade is configured to return to the selected position upon release of the finger from the structure. In other words, upon release of the finger from the structure, the guard blade returns to the preset hair cutting length setting.

According to a second aspect of the present invention, there is provided a hair-cutting device comprising a housing unit and a cutting unit in accordance with any one of the preceding claims.

These and other aspects of the present invention will become apparent from and be elucidated with reference to the embodiments described hereinafter.

### BRIEF DESCRIPTION OF THE DRAWINGS

These and other aspects of the invention will be apparent from and elucidated further with reference to the embodiments described by way of examples in the following description and with reference to the accompanying drawings, in which

FIG. 1 schematically shows a hair-cutting device according to some embodiments of the present disclosure;

FIGS. 2A and 2B schematically show side view of a tip region of a cutting unit according to some embodiments of the present disclosure in short and long cutting configurations, respectively; and

FIGS. 3A and 3B schematically show side view of a tip region of a cutting unit according to some other embodiments of the present disclosure in short and long cutting configurations, respectively.

It should be noted that the figures are purely diagrammatic and not drawn to scale. In the figures, elements which correspond to elements already described may have the same reference numerals. Examples, embodiments or optional features, whether indicated as non-limiting or not, are not to be understood as limiting the invention as claimed.

### DETAILED DESCRIPTION OF THE EMBODIMENTS

The present disclosure will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present disclosure are illustrative and are not intended to be limiting in any way. Other embodiments of the present disclosure will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

A person skilled in the art should note that directional terms, such as “above,” “below,” “upper,” “lower,” and other like terms are used in the description for the convenience of the reader in reference to the drawings. Also, a person skilled in the art should notice this description may contain other terminology to convey position, orientation, and direction without departing from the principles of the present disclosure.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

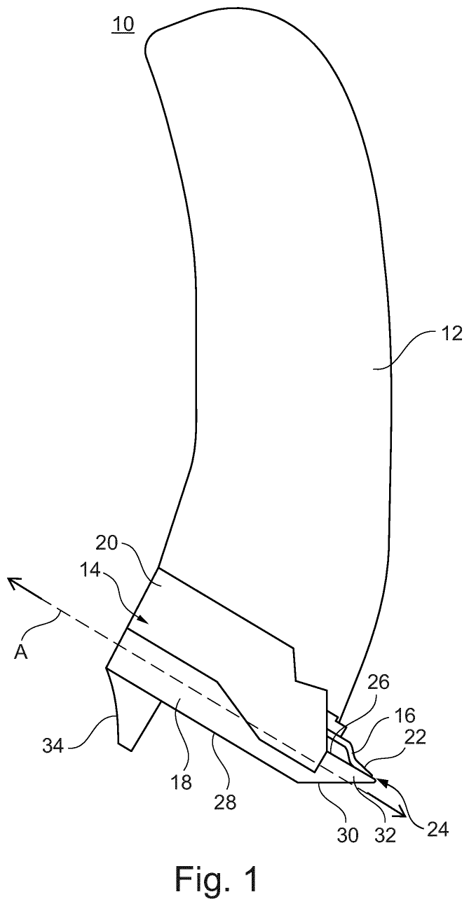

FIG. 1 schematically shows a hair-cutting device 10 comprising a housing unit 12 and a cutting unit 14. In this example, the housing unit 12 is generally in the form of a handle shaped for being hold by a user. The housing unit 12 may comprise functional systems of the cutting device, such as a power system (e.g. batteries and a charging unit), and a drive for driving reciprocating movement of a cutter blade of the hair-cutting device. In the orientation shown in FIG. 1, the housing unit 12 extends from a rounded upper end to a lower housing base for engaging the cutting unit 14.

The cutting unit 14 comprises a cutter blade 16 and a guard blade 18. The cutter blade 16 and the guard blade 18 may be coupled to a blade carrier 20. In this example, the blade carrier 20 is statically mounted to the housing unit 12 such that it is provided against the lower housing base of the housing unit 12. The blade carrier 20 may have an outer profile substantially corresponding to an outer profile of the housing unit 12 at the lower housing base. The profile may be substantially rectangular with rounded corners, for example.

The cutter blade 16 may be held by the blade carrier 20 and extends from a forward end of the blade carrier 20 (the right end of the blade carrier as shown in FIG. 1) and terminates at a first toothed leading edge 22 in a tip region of the cutting unit 14. In this example, the blade carrier 20 holds the cutter blade 16 for reciprocating movement along a transverse axis parallel with the cutting edge.

The guard blade 18 may be coupled to the blade carrier 20 such that it is disposed at a lower end of the hair-cutting device 10 as shown in the orientation of FIG. 1. In this example, the guard blade 18 has a squat generally cuboidal body having a tip at a forward end of the guard (i.e. in the tip region of the cutting unit 14) defined by a chamfer in the lower side of the guard. The guard blade 18 has a blade-facing surface 26 at least engaging the cutter blade 16 at a cut location 24 defined where the first toothed leading edge 22 contacts the blade-facing surface 26 of the guard blade. In this example, the blade-facing surface 26 is a substantially planar upper surface 26, which extends over the tip. The guard blade 18 also has a parallel substantially planar lower surface 28, which terminates at a proximal end of the chamfered tip, and a guard contact surface 30, which defines the underside of the tip for contacting skin of a user.

In this example, the guard contact surface 30 is inclined with respect to the blade-facing surface 26. They converge towards a second toothed leading edge 32, which has a plurality of hair-receiving slots for receiving hairs for cutting and guiding hairs to the cut location 24.

At least one of the cutter blade 16 and the guard blade 18 is configured to reciprocate in a reciprocation direction such that the leading edge 22 of the cutter blade is in a hair shearing relationship with the second toothed leading edge 32 of the guard blade. For example, the blade carrier 20 may hold the cutter blade 16 for reciprocating movement along a transverse axis parallel with the cutting edge (i.e. normal to the cross section as shown in FIG. 1). For example, such reciprocating movement may be driven by a drive of the housing unit 12.

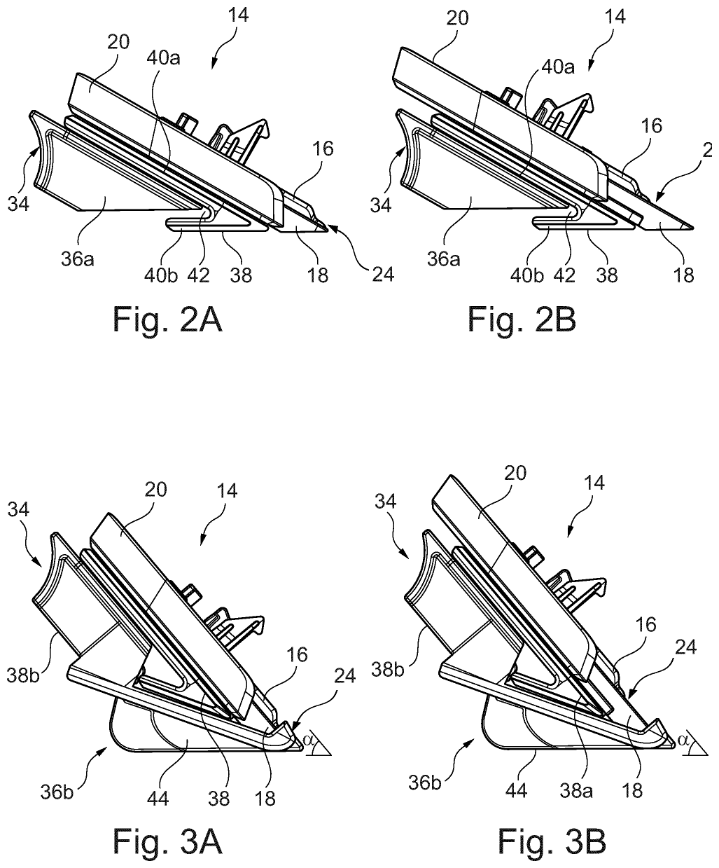

The guard blade 18 is a longitudinally moveable blade mounted for moving in a direction perpendicular to the reciprocation direction so as to adjust a length of hairs sheared between the guard blade and the cutter blade 16. In other words, the guard blade 18 is moveable forward and backward along an extension axis A parallel with the blade-facing surface 26 of the guard blade 18. Such movement may vary a cutting length of the cutting unit 14. A cutting unit in short and long cutting configurations is illustrated in FIGS. 2A and 2B as well as in FIGS. 3A and 3B.

When the guard contact surface 30 is held against skin of the user, a cutting length of the cutting unit 14 is equal to the distance from the guard contact surface 30 to the cut location 24. As will be appreciated, movement of the guard blade 18 along the extension axis A varies the cutting length.

The guard blade 18 may be presetable in a position selected from a set of predefined positions to allow a selection of different hair cutting length settings, e.g. 3.0 mm, 6.0 mm, 9.0 mm, etc. The predefined and discrete hair cutting length settings give less freedom to create stepless change or gradient in hair length.

The guard blade 18 may comprise a structure 34 being accessible by a finger of the user to move the guard blade in the direction perpendicular to the reciprocation direction to allow a continuous adjustment of the length of hairs sheared between the guard blade 18 and the cutter blade 16. In this example, the structure 34 is in the form of a knob that projects on a backward end of the guard blade 18 (the left end of the guard blade as shown in FIG. 1). The knob may be e.g. a click-on knob or a foldable knob. In other examples (not shown), the structure 34 may be a button or a recess. The surface of the structure 34 (e.g. button, knob, recess, etc.) may be knurled to facilitate manual operation by the finger of the user.

In operation, the user pushes the structure 34 forward towards the cut location 24, which shifts the guard blade 18 in a forward direction to increase the length of hairs sheared between the guard blade 18 and the cutter blade 16. Optionally, the guard blade 18 may be configured to be disengaged from a selected position during use when the structure is pressed inwardly, thus permitting slidable movement thereof. In other words, in order to adjust the cutting length, the user may be required to press the structure 34 by the finger to disengage the guard blade from a selected position followed by stepless sliding the guard blade by the same finger to create a continuous fade. The guard blade 18 may be configured to return to the selected position again upon release of the finger from the structure. This may be achieved by using a biasing spring (not shown). The biasing spring may be coupled to the guard blade to force the guard blade back to the selected position when the structure is released. As the user is required to press the structure inwardly to override the presently used cutting length setting, accidental changing of the length setting during trimming may be prevented.

FIGS. 2A and 2B illustrate an enlarged view of a further example of a cutting unit 14. In particular, FIG. 2A shows an enlarged view of the tip region of the cutting unit 14 with the guard blade in a first guard position corresponding to a short cutting length between the guard contact surface and the cut location. In contrast, FIG. 2B shows an enlarged view of the tip region of the cutting unit 14 in a second guard position corresponding to a long cutting length between the guard contact surface and the cut location.

The cutting unit 14 comprises a cutter blade 16 and a guard blade 18 substantially the same as described above with respect to FIG. 1.

In this example, the structure 34 is an attachment 36a, which may be made of plastic. The attachment 36 is attachable to the guard blade 18, e.g. via an adapter. An exemplary adapter 38 illustrated in FIG. 2 is mounted to the guard blade 18. The exemplary adapter 38 has a first flat piece 40a opposing to the guard blade 18 and a second flat piece 40b provided for contacting skin of the user. The first flat piece 40a and the second flat piece 40b converge towards a tip, thereby forming a recess 42 to hold the attachment 36a.

In operation, the user inserts the attachment 36a into the recess 42 and pushes the attachment 36a forward towards the cut location, which shifts the guard blade 18 in a forward direction to increase the length of hairs sheared between the guard blade 18 and the cutter blade 16 to create a continuous fade. The change in fade length may be in a range of 2 mm to 10 mm, e.g. at approx. 4.5 mm, depending on the configuration of the hair-cutting device. Optionally, in order to adjust the cutting length, the user may be required to press the the attachment 36a by the finger to disengage the guard blade from a selected position followed by stepless sliding the guard blade by the same finger to create a continuous fade. The guard blade 18 may be configured to return to the selected position again upon release of the finger from the structure. After use, the user may remove the attachment 36a from the recess 42.

FIGS. 3A and 3B illustrate an enlarged view of a further example of a cutting unit 14. In particular, FIG. 3A shows an enlarged view of the tip region of the cutting unit 14 with the guard blade in a first guard position corresponding to a short cutting length between the guard contact surface and the cut location. In contrast, FIG. 3B shows an enlarged view of the tip region of the cutting unit 14 in a second guard position corresponding to a long cutting length between the guard contact surface and the cut location.

The cutting unit 14 comprises a cutter blade 16 and a guard blade 18 substantially the same as described above with respect to FIG. 1 and FIG. 2.

In this example, the attachment is a comb arrangement 36b with a frontal portion 44 arranged to be disposed at the guard contact surface of the guard blade to create a tilt angle α between the cutting unit and the skin of the user. The comb arrangement 36b has a dorsal portion 38b, which is structured to be coupleable to the exemplary adapter 26.

In operation, the user attaches the comb arrangement 36b to the cutting unit and pushes the structure 34 forward towards the cut location, which shifts the guard blade 18 in a forward direction to increase the length of hairs sheared between the guard blade 18 and the cutter blade 16 to create a continuous fade. With the tilt angle α, the change in fade length may be e.g. in a range of 2 mm to 15 mm, e.g. at approx. 9 mm. Thus, the fade length difference may increase from 4.5 mm (without using a comb) to 9 mm (with the use of a fade comb).

Optionally, in order to adjust the cutting length, the user may be required to press the structure 34 by the finger to disengage the guard blade from a selected position followed by stepless sliding the guard blade by the same finger to create a continuous fade. The guard blade 18 may be configured to return to the selected position again upon release of the finger from the structure. After use, the user may detach the comb arrangement 36b from the cutting unit 14.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

It has to be noted that embodiments of the invention are described with reference to different subject matters. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

1. A cutting unit for a hair-cutting device, comprising:
a cutter blade with a first toothed leading edge;
a guard blade comprising:
a blade-facing surface at least engaging the cutter blade at a cut location;
a guard contact surface for contacting skin of a user; and
a substantially planar lower surface terminating at the guard contact surface and, the planar lower surface being parallel to the blade facing surface;
wherein the guard contact surface and the blade-facing surface are angled with respect to each other and converge towards a second toothed leading edge with a plurality of hair-receiving slots;
wherein at least one of the cutter blade and the guard blade is configured to reciprocate in a reciprocation direction such that the first toothed leading edge of the cutter blade is in a hair shearing relationship with the second toothed leading edge of the guard blade;
wherein the guard blade is a longitudinally moveable blade mounted for moving in a direction perpendicular to the reciprocation direction so as to adjust a length of hairs sheared between the guard blade and the cutter blade;
wherein the guard blade comprises a structure being accessible by a finger of the user to move the guard blade in the direction perpendicular to the reciprocation direction to allow a continuous adjustment of the length of hairs sheared between the guard blade and the cutter blade;
wherein the structure is located on the planar lower surface of the guard blade;
wherein the guard blade is presetable in a position selected from a set of predefined positions to allow a selection of different hair cutting length settings; and
wherein the guard blade is configured to return to the selected position upon release of the finger from the structure.

2. The cutting unit according to claim 1,
wherein the structure is an integral part of the guard blade.

3. The cutting unit according to claim 1,
wherein the structure is an attachment attachable to the guard blade, wherein the attachment is accessible by a finger of the user to move the guard blade in the direction perpendicular to the reciprocation direction, when being attached to the guard blade.

4. The cutting unit according to claim 3,
wherein the attachment is a comb arrangement with a frontal portion arranged to be disposed at the guard contact surface of the guard blade to create a tilt angle between the cutting unit and the skin of the user.

5. (canceled)

6. (canceled)

7. (canceled)

8. The cutting unit according to claim 1, further comprising:
a biasing spring coupled to the guard blade configured to force the guard blade back to the selected position upon release of the finger from the structure.

9. A hair-cutting device comprising a housing unit and a cutting unit in accordance with claim 1.
